(19) United States
(12) Patent Application Publication
(10) Pub. No.: US 2026/0104599 A1
(43) Pub. Date: Apr. 16, 2026

(54) ADHESIVE ARRANGEMENTS FOR WAVEGUIDE DEVICES, AND RELATED APPRATUS AND METHODS

(71) Applicant: Applied Materials, Inc., Santa Clara, CA (US)

(72) Inventors: Daniel ADEMA, Kitchener (CA); Kazuya DAITO, Milpitas, CA (US); Neal RICKS, San Jose, CA (US); Darren IHMELS, Port Moody (CA); Davide COLLA, Treviso (IT)

(21) Appl. No.: 19/347,367

(22) Filed: Oct. 1, 2025

Related U.S. Application Data
(60) Provisional application No. 63/707,613, filed on Oct. 15, 2024.

(51) Int. Cl. G02C 9/00; G02B 27/01; G02C 7/08

(52) U.S. Cl. CPC G02C 9/00; G02B 27/0172; G02C 7/086; G02C 2202/16

(57) ABSTRACT

Embodiments described herein relate to adhesive arrangements for waveguide devices, and related apparatus and methods. In one or more embodiments, the adhesive arrangements facilitate adhering strength, reduction and/or distribution of stress, withstanding of thermal cycles, and impact resistance. In one or more embodiments, a device includes a substrate and a lens coupled to the substrate using an adhesive. The substrates has a first face, a second face, and an outer edge. The first face of the substrate includes a waveguide, and the waveguide includes an input coupling grating, a pupil expansion grating, and an output coupling grating. The waveguide is disposed radially inwardly of the adhesive, and the device has an edge offset between an outer edge of the lens and the outer edge of the substrate.

### CROSS-REFERENCE TO RELATED APPLICATION

This application claims the benefit of U.S. provisional patent application Ser. No. 63/707,613, filed Oct. 15, 2024, which is herein incorporated by reference in its entirety.

### BACKGROUND

### Field

Embodiments of the present disclosure generally relate to waveguides. More specifically, embodiments described herein relate to adhesive arrangements for waveguide devices, and related apparatus and methods

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. Waveguides, such as augmented reality waveguides, are used to assist in overlaying images. Generated light is propagated through a waveguide until the light exits the waveguide and is overlaid on the ambient environment. For waveguide devices it can be difficult to use adhesive that involves strong adhesion and undergoes thermal cycling. Moreover, it can be difficult to have waveguide devices that are impact resistant.

Accordingly, what is needed in the art are waveguide devices that facilitate reliability, strong adhesion, and impact resistance.

### SUMMARY

Embodiments described herein relate to adhesive arrangements for waveguide devices, and related apparatus and methods. In one or more embodiments, the adhesive arrangements facilitate adhering strength, reduction and/or distribution of stress, withstanding of thermal cycles, and impact resistance.

In one or more embodiments, a device includes a substrate and a lens coupled to the substrate using an adhesive. The substrates has a first face, a second face, and an outer edge. The first face of the substrate includes a waveguide, and the waveguide includes an input coupling grating, a pupil expansion grating, and an output coupling grating. The waveguide is disposed radially inwardly of the adhesive, and the device has an edge offset between an outer edge of the lens and the outer edge of the substrate.

In one or more embodiments, a device includes a substrate and a lens coupled to the substrate using an adhesive. The substrate has a first face, a second face, and an outer edge. The first face of the substrate includes a waveguide. An outer face of the lens includes a tapered section extending to an outer edge of the lens.

In one or more embodiments, a device includes a substrate and a lens coupled to the substrate using an adhesive. The substrate has a first face, a second face, and an outer edge. The first face of the substrate includes a waveguide. The lens includes a first outer face adhered to the adhesive, a second outer face on an opposite side of the lens, and one or more recesses formed in the second outer face.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a perspective, frontal view of a waveguide, according to one or more embodiments.

FIG. 2 is a schematic cross-sectional view of the device shown in FIG. 1, according to one or more embodiments.

FIG. 3 is a schematic cross-sectional view of a device, according to one or more embodiments.

FIG. 4 is schematic partial cross-sectional view of the device shown in FIG. 3, according to one or more embodiments.

FIG. 5 is schematic partial cross-sectional view of the device shown in FIG. 3, according to one or more embodiments.

FIGS. 6 and 7 are schematic partial cross-sectional views of the device shown in FIG. 3, according to one or more embodiments.

FIGS. 8 and 9 are schematic partial cross-sectional views of the device shown in FIG. 3, according to one or more embodiments.

FIG. 10 is a schematic partial cross-sectional view of the device shown in FIG. 3, according to one or more embodiments.

FIG. 11 is a schematic partial cross-sectional view of the device shown in FIG. 3, according to one or more embodiments.

FIGS. 12-14 are schematic partial cross-sectional views of the device shown in FIG. 3, according to one or more embodiments.

FIG. 15 is a schematic partial cross-sectional view of a tapered section of the lens, according to one or more embodiments.

FIG. 16 is a schematic projection view of the shelf of the respective lens, according to one or more embodiments.

FIG. 17 is a schematic projection view of the shelf of the respective lens, according to one or more embodiments.

FIG. 18 is a schematic cross-sectional view, along Section 18-18, of the openings shown in FIG. 17, according to one or more embodiments.

FIG. 19 is a schematic projection view of the shelf of the respective lens, according to one or more embodiments.

FIG. 20 is a schematic projection view of a pattern of the adhesive, according to one or more embodiments.

FIG. 21 is a schematic projection view of a pattern of structural adherents and adhesive, according to one or more embodiments.

FIG. 22 is a schematic projection view of a pattern of the adhesive, according to one or more embodiments.

FIG. 23 is a flow diagram of a method of fabricating a device, according to one or more embodiments.

FIGS. 24A-24D are schematic cross-sectional views of a substrate during fabrication of the device, according to one or more embodiments.

FIGS. 25A-25D are cross-sectional views of a substrate during a method of fabrication of a device, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein relate to adhesive arrangements for waveguide devices, and related apparatus and methods. In one or more embodiments, the adhesive arrangements facilitate adhering strength, reduction and/or distribution of stress, withstanding of thermal cycles, and impact resistance.

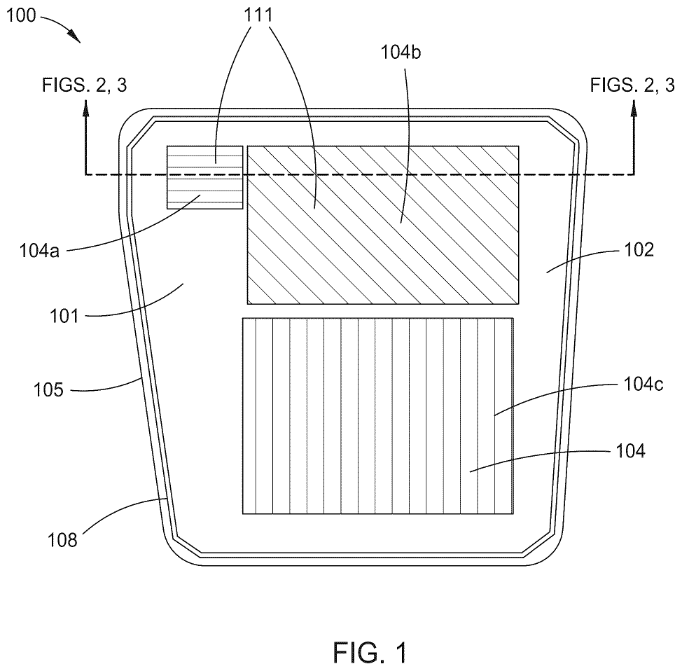

FIG. 1 is a perspective, frontal view of a device 100, according to one or more embodiments. It is to be understood that the device 100 described herein is an exemplary waveguide and that other waveguides may be used with or modified to accomplish aspects of the present disclosure. The device 100 includes a plurality of structures 111. The structures 111 may be disposed over, under, or on a first face 102 of a substrate 101, or disposed in the substrate 101. The structures 111 are nanostructures and have a sub-micron critical dimension, e.g., a width less than 1 micrometer. Regions of the structures 111 correspond to one or more gratings 104. In one or more embodiments, the device 100 includes at least a first grating 104a corresponding to an input coupling grating and a third grating 104c corresponding to an output coupling grating. In one or more embodiments, the device 100 further includes a second grating 104b. The second grating 104b corresponds to a pupil expansion grating or a fold grating.

The substrate 101 may also be selected to transmit a suitable amount of light of a desired wavelength or wavelength range, such as one or more wavelengths from about 100 to about 3000 nanometers. Without limitation, in one or more embodiments, the substrate 101 is configured such that the substrate 101 transmits greater than or equal to about 50% to about 100%, of an infrared to ultraviolet region of the light spectrum. The substrate 101 may be formed from any suitable material, provided that the substrate 101 can adequately transmit light in a desired wavelength or wavelength range and can serve as an adequate support for the device 100 described herein. Substrate selection may include optical device substrates of any suitable material, including, but not limited to, amorphous dielectrics, non-amorphous dielectrics, crystalline dielectrics, silicon oxide, polymers, and combinations thereof. In some embodiments, which may be combined with other embodiments described herein, the substrate 101 includes a transparent material. In one or more embodiments, the substrate 101 is transparent with absorption coefficient smaller than 0.001. Suitable examples may include silicon (Si), silicon dioxide (SiO₂), fused silica, quartz, silicon carbide (SiC), germanium (Ge), silicon germanium (SiGe), indium phosphide (InP), gallium arsenide (GaAs), gallium nitride (GaN), sapphire, lithium tantalate (LiTaO₃), lithium niobate (LiNbO₃), or combinations thereof. In one or more embodiments, the substrate 101 has a substrate refractive index greater than 1.4, such as greater than 1.6, such as about 1.8, or about 2.0.

In one or more embodiments, the structures 111 are disposed in the substrate 101. In one or more embodiments, the structures 111 are disposed on or over the substrate 101. The structures 111 include a device material. The device material includes, but is not limited to, silicon carbide (SiC), silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), silicon mononitride (SiN), silicon oxynitride (SiON), barium titanate (BaTiO₃), diamond like carbon (DLC), hafnium(IV) oxide (HfO₂), lithium niobate (LiNbO₃), silicon carbon-nitride (SiCN), or combinations thereof.

In operation of the device 100 a virtual image is projected from a near-eye display, such as a microdisplay, to the first grating 104a. The structures 111 of the first grating 104a in-couple the incident beams of light of the virtual image and diffract the incident beams to the second grating 104b. The diffracted beams undergo total-internal-reflection (TIR) until through the device 100 until the diffracted beams come in contact with structures 111 of the second grating 104b. The diffracted beams from the first grating 104a incident on the second grating 104b are split into a first portion beams refracted back or lost in the device 100, a second portion beams that undergo TIR in the second grating 104b until the second portion beams contact another structure of the plurality of structures 111 of the second grating 104b, and a third portion of beams that are coupled through the device 100 to the third grating 104c. The beams of the second portion of beams that undergo TIR in the second grating 104b continue to contact structures of the plurality of structures until the either the intensity of the second portion of beams coupled through the device 100 to the second grating 104b is depleted, or remaining second portion of beams propagating through the second grating 104b reach the end of the second grating 104b.

The beams pass through the device 100 to the third grating 104c and undergo TIR in the device 100 until the beams contact a structure of the plurality of gratings 104 of the third grating 104c where the beams are split into beams that are refracted back or lost in the device 100, beams that undergo TIR in the third grating 104c until the beams contact another structure of the plurality of gratings 104, or beams that are out-coupled from the device 100 to the user's eye. The beams that undergo TIR in the third grating 104c continue to contact structures of the plurality of gratings 104 until the either the intensity of the beams pass through the device 100 to the third grating 104c is depleted, or remaining beams propagating through the third grating 104c have reached the end of the third grating 104c. The beams of the virtual image are propagated from the third grating 104c to overlay the virtual image over the ambient environment.

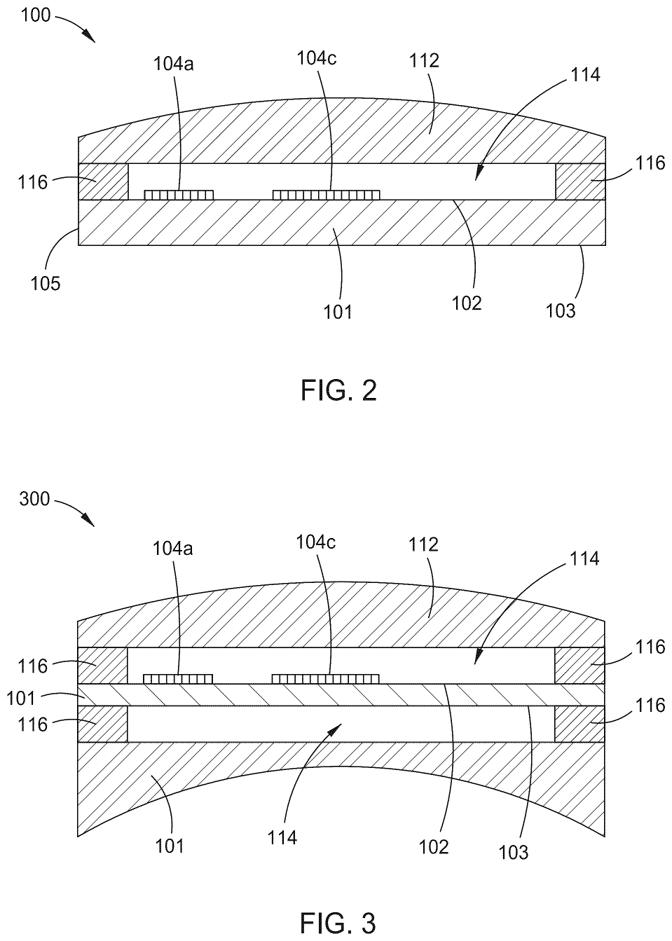

FIG. 2 is a schematic cross-sectional view of the device 100 shown in FIG. 1, according to one or more embodiments. The device 100 is an optical device, such as a waveguide device.

The device 100 includes a substrate 101 having a first face 102, a second face 103, and an outer edge 105. The first face 102 of the substrate 101 includes the waveguide. The device 100 includes a lens 112 coupled to the substrate 101 using an adhesive 116. The waveguide is disposed radially inwardly of the adhesive 116. In one or more embodiments, the adhesive 116 includes a pressure sensitive adhesive, a heat-activated adhesive, and/or a glue. The present disclosure contemplates that other adhesives may be used. A gap 114 is between the substrate 101 and the lens 112, and the waveguide is disposed in the gap 114. A size of the gap 114 can be defined at least partially by a thickness of the adhesive 116. The composition of the gap 114 can include air having a refractive index of less than 1.4 (such as 1.0) and an absorption coefficient of 0. A coating, such as a mirror coating, can be disposed on the first face 102 of the substrate 101. The gap 114 between the lens 112 and the substrate 101 can have a height of less than or equal to 0.1 mm, such as less than 0.050 mm, such as about 0.1 mm, such as about 0.030 mm, about 0.020 mm or about 0.0025. In one or more embodiments, the lens 112 is a world-side lens and the second lens 120 is an eye-side lens.

FIG. 3 is a schematic cross-sectional view of a device 300, according to one or more embodiments. The device 300 is similar to the device 100 shown in Figures and 2, and includes one or more aspects, features, components, operations and/or properties thereof.

The device 100 includes a second lens 120 coupled to an opposite side (e.g., the second face 103) of the substrate 101 using the adhesive 116.

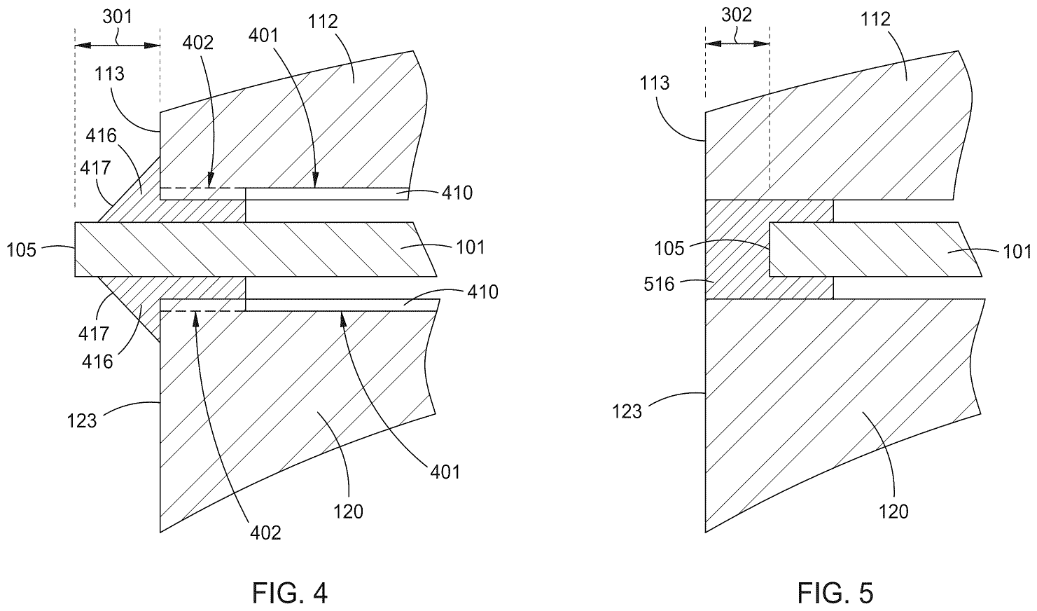

FIG. 4 is schematic partial cross-sectional view of the device 300 shown in FIG. 3, according to one or more embodiments.

In the implementation shown in FIG. 4, the lens 112 and the second lens 120 are coupled to opposing sides of the substrate 101 using an adhesive 416. The adhesive 416 can be used, for example, as the adhesive 116 in FIG. 2 and/or FIG. 3. The device 300 has an edge offset 301 between an outer edge 113 of the lens 112 and the outer edge 105 of the substrate 101. The edge offset 301 is also between an outer edge 123 of the second lens 120 and the outer edge 105 of the substrate 101. The outer edge 105 of the substrate 101 extends radially outwardly past the outer edge 113 of the lens 112 and/or past the outer edge 123 of the second lens 120, and the adhesive 416 extends radially outwardly of the outer edge 113 of the lens 112. The adhesive 416 includes a tapered outer face 417 having a taper that is curved or linear. In one or more embodiments, the curved taper is in the shape of a parabola, part of a circle, and/or part of an oval.

A respective outer face of the lens 112 and/or the second lens 120 includes a coating 410 formed on an inner section 401 of the respective outer face, and an outer section 402 of the outer face is uncoated. The outer section 402 can remain uncoated while the coating 410 is formed, or the coating 410 can be removed such that the outer section 402 is uncoated. The adhesive 416 is adhered to at least part of the outer section 402 that is uncoated. In addition to or in place of the adhesive 416, the outer section 402 is roughened to increase a surface roughness of the outer section 402 relative to the inner section 401. In one or more embodiments, the adhesive 416 extends to contact (e.g., cover) and entirety of the outer section 402. The coating removal and/or roughening can include for example machining, abrasive tooling, wire-brush tooling, score tooling, engraving tooling, sandblasting, bead blasting, ion bombardment, etching (such as plasma etching), and/or light texturing (such as laser texturing). The coating 410 (if used) can be roughened and/or a surface of the lens 112 can be roughened. The coatings described herein can be deposited, for example, using an FEOL process operation and/or a dip coat operation. The coatings and/or the adhesive described herein can be cured (for example, using ultraviolet (UV) curing). The removal and/or roughening can establish patterned features that can vary, for example, in relation pitch, depth, location, spacing, and/or one or more other parameters. The patterned features can be, for example, in the pattern of a cross-hatch.

FIG. 5 is schematic partial cross-sectional view of the device 300 shown in FIG. 3, according to one or more embodiments.

In the implementation shown in FIG. 5, the lens 112 and the second lens 120 are coupled to opposing sides of the substrate 101 using an adhesive 516. The adhesive 516 can be used, for example, as the adhesive 116 in FIG. 2 and/or FIG. 3. The device 300 has an edge offset 302 between an outer edge 113 of the lens 112 and the outer edge 105 of the substrate 101. The edge offset 302 is also between an outer edge 123 of the second lens 120 and the outer edge 105 of the substrate 101.

The outer edge 113 of the lens 112 extends radially outwardly past the outer edge 105 of the substrate 101, and at least part of the adhesive 516 is disposed radially outwardly of the outer edge 105 of the substrate 101. The outer edge 123 of the second lens 120 extends radially outwardly past the outer edge 105 of the substrate 101.

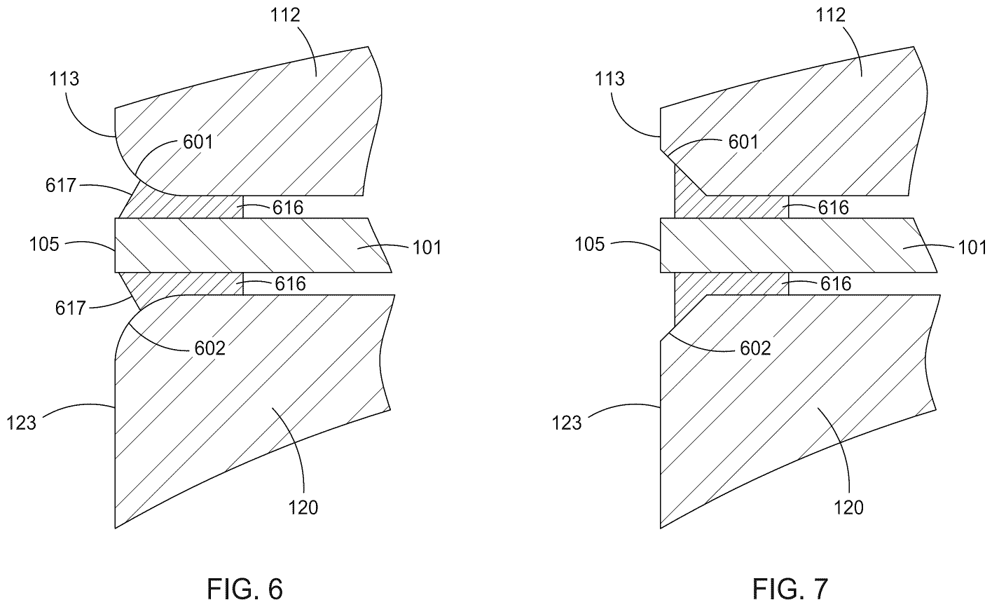

FIGS. 6 and 7 are schematic partial cross-sectional views of the device 300 shown in FIG. 3, according to one or more embodiments.

In the implementations shown in FIG. 6 and FIG. 7, the lens 112 and the second lens 120 are coupled to opposing sides of the substrate 101 using an adhesive 616. The adhesive 616 can be used, for example, as the adhesive 116 in FIG. 2 and/or FIG. 3. In one or more embodiments (as shown in FIG. 6), the adhesive 616 includes a tapered outer face 617 having a taper that is curved (e.g., a fillet) or linear (e.g., a chamfer or bevel). A respective outer face of the lens 112 and the second lens 120 includes a tapered section 601, 602 extending respectively to the outer edge 113 of the lens 112 and the outer edge 123 of the second lens 120. The tapered section 601, 602 is curved or linear, and the adhesive 616 extends to bond to the tapered section 601, 602. In one or more embodiments, the respective tapered section 601, 602 is curved (as shown in FIG. 6) and has a radius of curvature. In one or more embodiments, the respective tapered section 601, 602 is linear (as shown in FIG. 7) and has a taper angle.

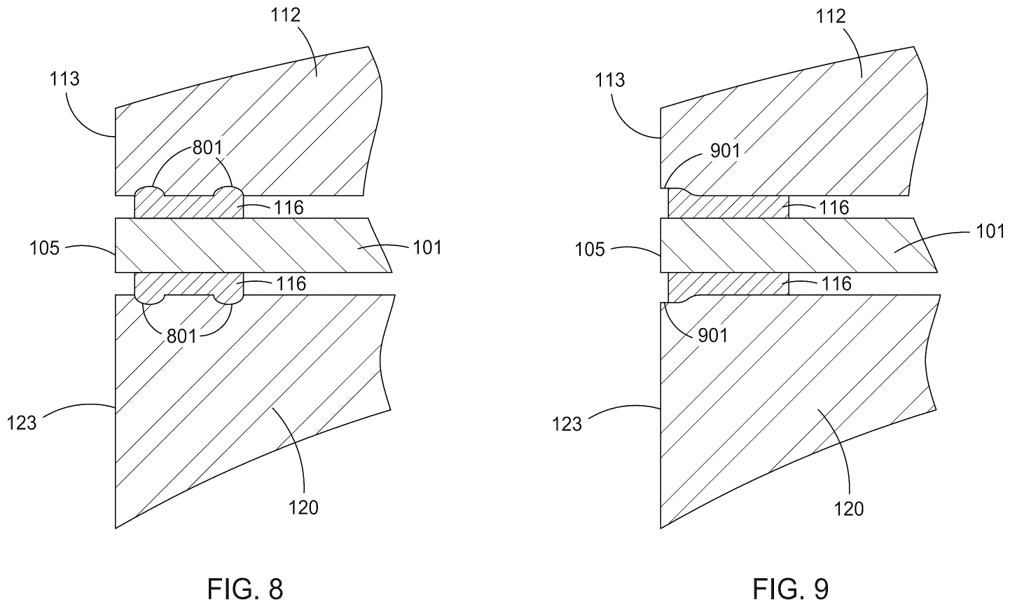

FIGS. 8 and 9 are schematic partial cross-sectional views of the device 300 shown in FIG. 3, according to one or more embodiments.

In the implementations shown in FIG. 8 and FIG. 9, a respective outer face of the lens 112 and the second lens 120 includes one or more recesses 801, 901, and the adhesive 116 at least partially fills the respective one or more recesses 801, 901. In the implementation shown in FIG. 8 a plurality of recesses 801 are spaced from each other and are disposed inwardly of the outer edges 113, 123 of the lenses 112, 120. In the implementation shown in FIG. 9, at least one recess 901 extends to the respective outer edge 113, 123.

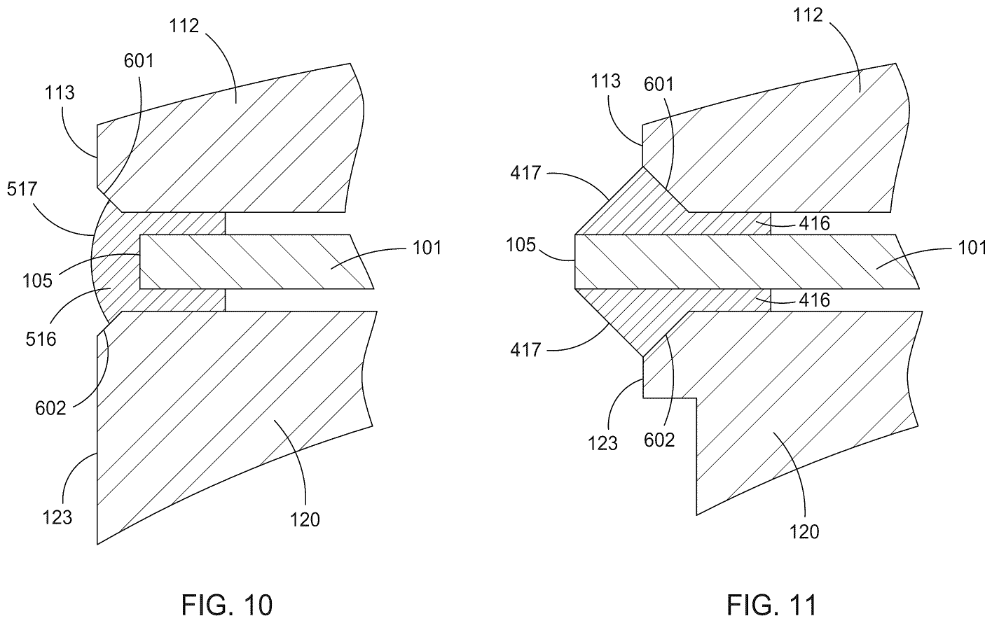

FIG. 10 is a schematic partial cross-sectional view of the device 300 shown in FIG. 3, according to one or more embodiments.

In the implementation shown in FIG. 10, the device 300 includes the adhesive 516 of FIG. 5 and the tapered sections 601, 602 of FIG. 6. The adhesive 516 includes a tapered outer surface 517 having a taper that is linear or curved (e.g., curved as shown in FIG. 10).

FIG. 11 is a schematic partial cross-sectional view of the device 300 shown in FIG. 3, according to one or more embodiments.

In the implementation shown in FIG. 11, the device 300 includes the adhesive 416 of FIG. 4 and the tapered sections 601, 602 of FIG. 6.

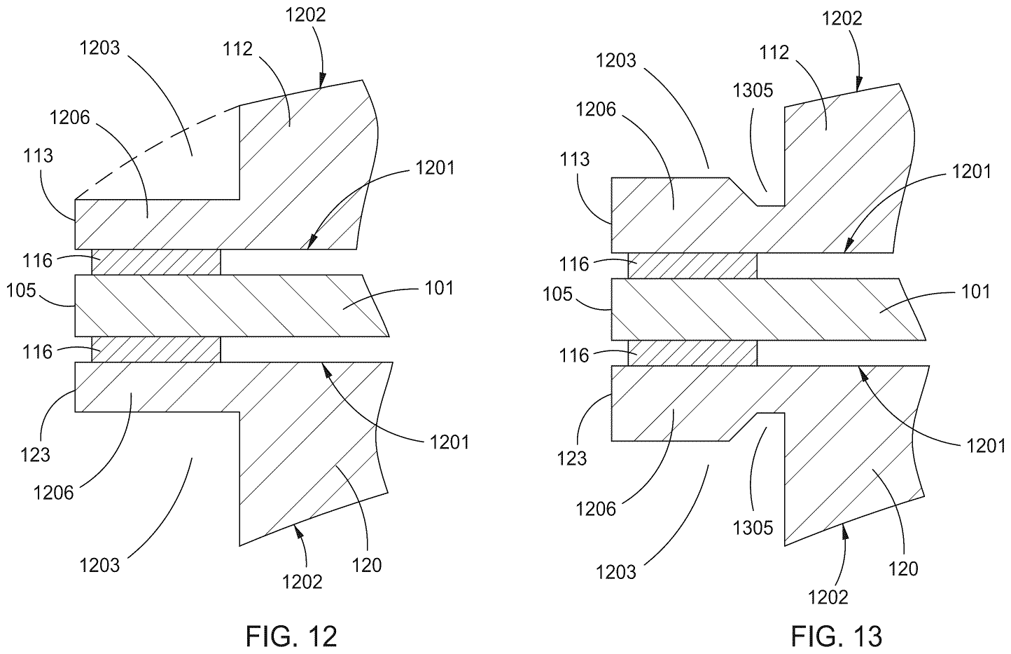

FIGS. 12-14 are schematic partial cross-sectional views of the device 300 shown in FIG. 3, according to one or more embodiments.

The lens 112 and the second lens 120 respectively include a first outer face 1201 adhered to the adhesive 116, a second outer face 1202 on an opposite side of the lens 112, 120, and one or more recesses 1203 (such as one or more notches) formed in the second outer face 1202. In one or more embodiments, at least one of the one or more recesses 1203 extends to the outer edge 113, 123 of the respective lens 112, 120. The one or more recesses 1203 are disposed radially inwardly of the outer edge 113, 123 of the respective lens 112, 120. The one or more recesses 1203 can reduce beam stiffness and can increase flexibility, which can facilitate impact resistance and reduced risk of breakage. The increased flexibility can reduce transmitted peel loads to the adhesive 116. The one or more recesses 1203 can define, for example, a shelf 1206 of the respective lens 112, 120.

In the implementation shown in FIG. 13, at least one of the one or more recesses 1203 includes a trench section 1305 that extends deeper into the shelf 1206 of the respective lens 112, 120.

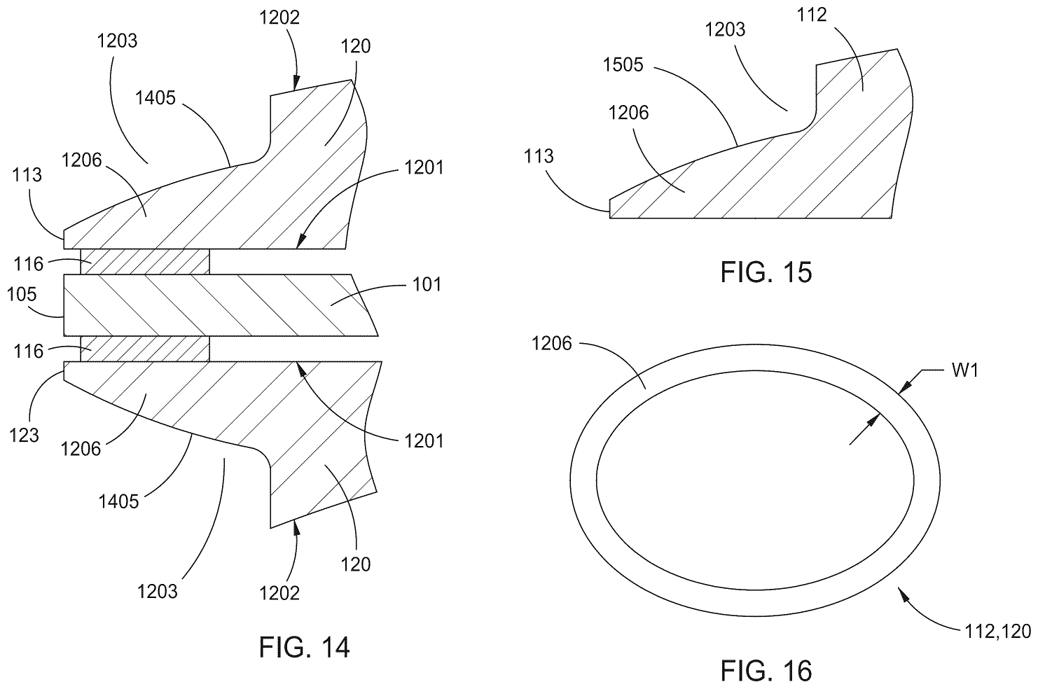

In the implementation shown in FIG. 14, at least one of the one or more recesses 1203 defines a tapered section 1405 of the second outer face 1202 of the respective lens 112, 120.

FIG. 15 is a schematic partial cross-sectional view of a tapered section 1505 of the lens 112, according to one or more embodiments.

In the implementation shown in FIG. 15 the tapered section 1505 is parabolic. The parabolic shape can facilitate increased tip deflection with constant stress, and ease of manufacturing.

FIG. 16 is a schematic projection view of the shelf 1206 of the respective lens 112, 120, according to one or more embodiments.

In the implementation shown in FIG. 16, the shelf 1206 has a continuous width W1 along an entirety of a circumference of the shelf 1206.

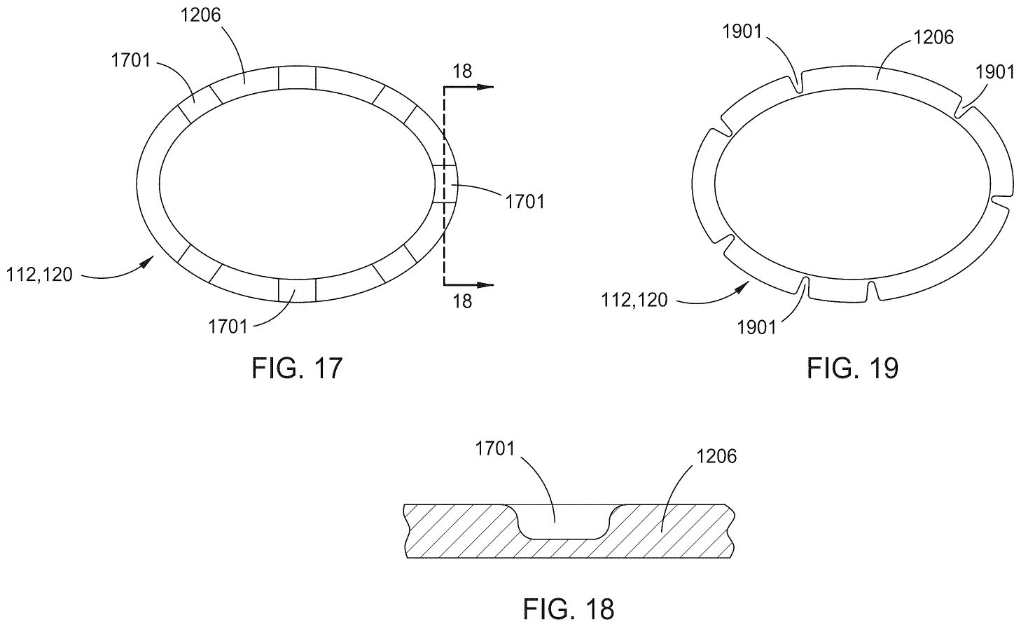

FIG. 17 is a schematic projection view of the shelf 1206 of the respective lens 112, 120, according to one or more embodiments.

In the implementation shown in FIG. 17, the respective lens 112, 120 includes a plurality of openings 1701 formed in the outer edge 113, 123 of the lens, and the plurality of openings 1701 are azimuthally spaced from each other.

FIG. 18 is a schematic cross-sectional view, along Section 18-18, of the openings 1701 shown in FIG. 17, according to one or more embodiments.

The openings 1701 extend partially into the shelf 1206 along a thickness direction to define low regions and thinner sections along the shelf 1206.

FIG. 19 is a schematic projection view of the shelf 1206 of the respective lens 112, 120, according to one or more embodiments.

In the implementation shown in FIG. 19, the respective lens 112, 120 includes a plurality of openings 1901 formed in the outer edge 113, 123 of the lens, and the plurality of openings 1901 are azimuthally spaced from each other. The openings 1901 extend through the shelf 1206 along a thickness direction. The openings 1901 can be used, for example, as locating datums for locating tabs to position the lens 112, 120 in relation to the substrate 101 and/or the other lens 112, 120.

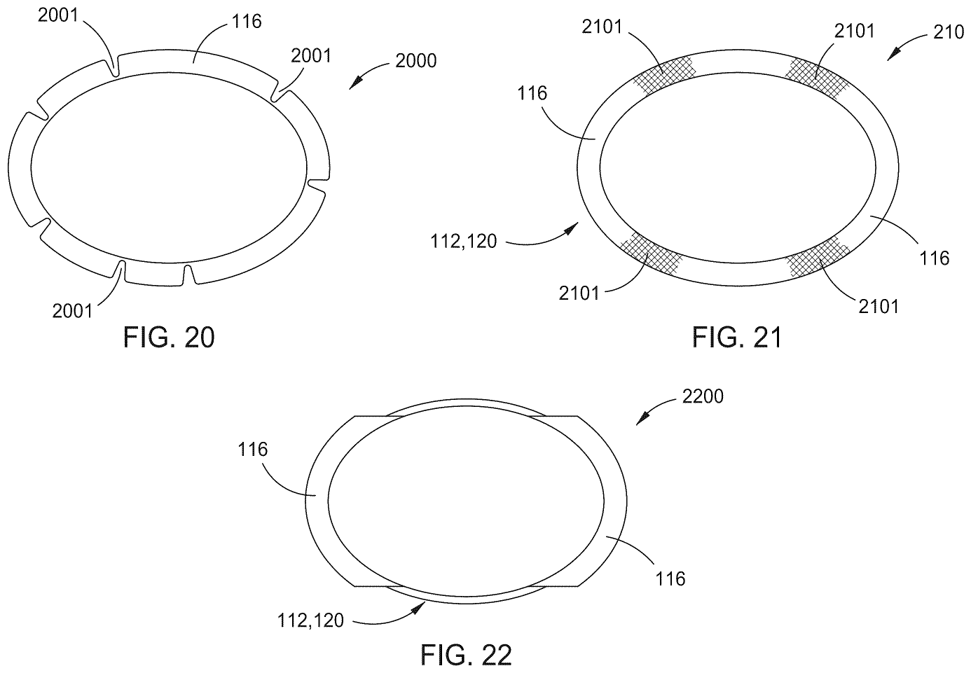

FIG. 20 is a schematic projection view of a pattern 2000 of the adhesive 116, according to one or more embodiments.

The adhesive 116 is formed to define a plurality of adhesive gaps 2001 that are azimuthally spaced from each other. In one or more embodiments, the shelf 1206 can be formed to include the openings 1901, which can limit regions of adhesive deposition in order to form the adhesive defining the adhesive gaps 2201, and which can reduce the developed length of the adhesive 116. The adhesive gaps 2201 can correspond (e.g., in size and/or shape) to the openings 1901.

FIG. 21 is a schematic projection view of a pattern 2100 of structural adherents 2101 and adhesive 116, according to one or more embodiments.

The structural adherents 2101 include a plurality of structural bonds between the substrate 101 and the respective lens 112, 120. In one or more embodiments, the structural adherents 2101 include beams extending between the substrate 101 and the respective lens, 112, 120. In one or more embodiments, sets of the structural adherents 2101 are azimuthally spaced from each other. The sets of structural adherents 2101 can be positioned, for example, at airy points or bessel points. The present disclosure contemplates structural adherents 2101 other than beams. The adhesive 116 can be disposed in regions azimuthally between the structural adherents 2101. In addition to or in place of the adhesive 116, venting can be disposed in regions azimuthally between the structural adherents 2101. The adhesive 116 can be omitted from the regions of the structural adherents 2101, or the adhesive 116 can be formed in on the regions of the structural adherents 2101. For example, the adhesive 116 can be disposed on the entirety of the shelf 1206. The patterns and regions can distribute (such as equalize) peak strains more uniformly. The present disclosure contemplates that bonding properties of the adhesive 116 may not be needed when the structural adherents 2101 are used, and the adhesive 116 may be used for sealing purposes. The present disclosure also contemplates that other materials (such as other sealant materials) may be used in place of the adhesive 116.

FIG. 22 is a schematic projection view of a pattern 2200 of the adhesive 116, according to one or more embodiments.

The present disclosure also contemplates that the shelf 1206 can be formed along the pattern 2200.

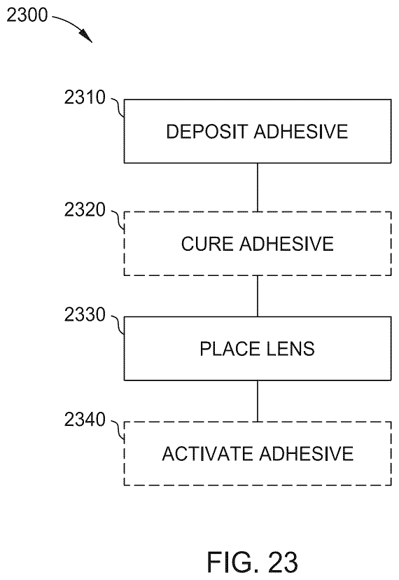

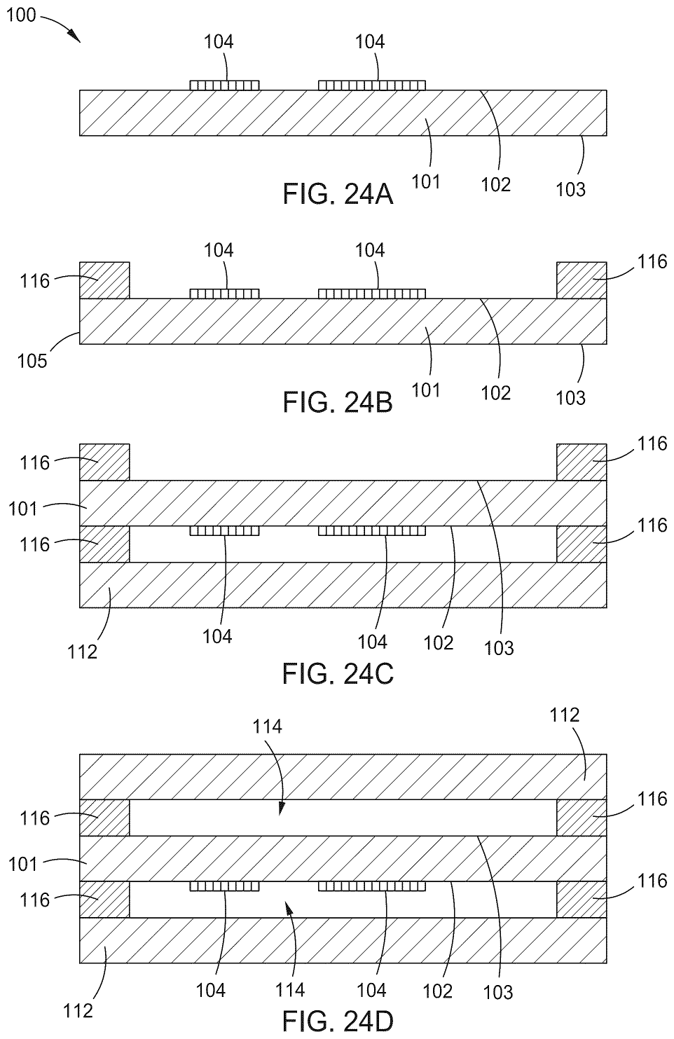

FIG. 23 is a flow diagram of a method 2300 of fabricating a device, according to one or more embodiments. FIGS. 24A-24D are schematic cross-sectional views of a substrate during fabrication of the device, according to one or more embodiments.

At operation 2310, adhesive 116 is deposited over a substrate 101, as shown in FIG. 24B. The substrate 101 includes a first face 102, a second face 103 and at least one grating 104, as shown in FIG. 24A. In one or more embodiments, the adhesive 116 is deposited by printing (such as screen printing, inkjet printing, and/or roller printing), dispensing, patterning, and/or spraying. In one or more embodiments, the adhesive is pre-fabricated (e.g., as a pre-form) into the shapes shown herein (such as the shapes of the cross sections of the adhesives 116, 416, 516, 616 shown in FIGS. 2-14 and/or the shapes of the patterns shown in FIGS. 20-22). For example, the adhesive 416 having the cross section and the tapered outer surface 417 shown in FIG. 4 can be pre-formed and then positioned between the lens 112 and the second lens 120.

At optional operation 2320, the adhesive 116 is cured, such as by UV curing and/or thermal curing.

At operation 2330, lens 112 or 120 is placed over the adhesive 116, as shown in FIG. 24C.

At optional operation 2340, the adhesive 116 is activated. In one or more embodiments, the activation includes applying pressure to the adhesive 116 (such as by pressing the lens 112 or 120 into the adhesive 116). In one or more embodiments, the activation includes applying temperature to the adhesive 116 (such as by heating the adhesive 116). One or more gap setting features can be positioned between the substrate 101 and the lens 112 or 120 to maintain the gap 114 (such as when the adhesive 116 includes glue). The present disclosure contemplates that the adhesive 116 can be cured again after the activation of operation 2340. The present disclosure contemplates that adhesive can have the shapes described herein (such as the shapes of the cross sections of the adhesives 116, 416, 516, 616 shown in FIGS. 2-14 and/or the shapes of the patterns shown in FIGS. 20-22) before curing and activation and/or after curing and activation.

As shown in FIG. 24D, additional adhesive 116 can be deposited over an opposing side of the substrate 101, and an additional lens 1112 can be placed over the additional adhesive 116. The additional adhesive 116 can be cured and activated, as described above.

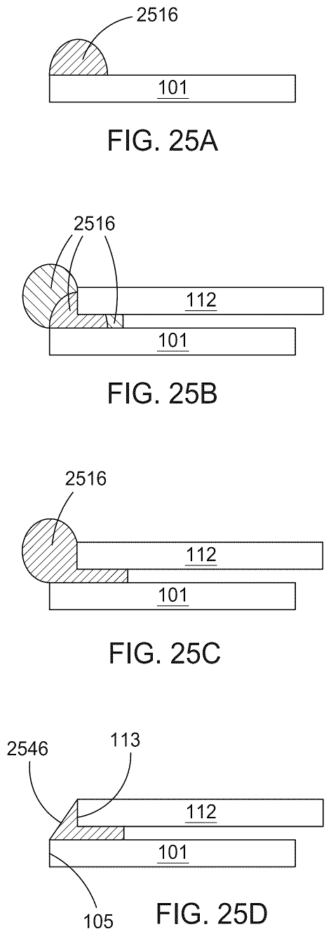

FIGS. 25A-25D are schematic partial cross-sectional views of a substrate during a method 2500 of fabrication of a device, according to one or more embodiments.

At FIG. 25A, an adhesive material 2516 is deposited on the substrate 101. The deposition can occur, for example, as described for operation 2310 of the method 2300.

At FIG. 25B, the lens 112 is positioned to contact the adhesive material 2516. The contact can optionally activate the adhesive material 2516.

At FIG. 25C, the adhesive material 2516 is cured and/or activated. The curing and/or activation can occur, for example, as described for operation 2320 and/or operation 2340 of the method 2300.

At FIG. 25D, the adhesive material is shaped 2516, for example, into an adhesive 2546. The adhesive 2546 is similar to the adhesive 416 of FIG. 4, and the adhesive 2546 extends to contact (e.g., cover) an entirety of the outer edge 113 of the lens 112. The shaping can remove portions of the adhesive material 2516 to form the adhesive 2546. The shaping can include for example machining, abrasive tooling, wire-brush tooling, score tooling, engraving tooling, sandblasting, bead blasting, ion bombardment, etching (such as plasma etching), and/or light-base removal (such as laser removal). The shaping can form other shapes and/or patterns, such as the shapes of adhesives 116, 516, 616.

As described above, the adhesives described herein can be pre-formed such that shaping is not needed after the positioning of the lens 112 in FIG. 25B.

The present disclosure contemplates that the operations of FIGS. 25A-25D can be repeated, such as in relation to the second lens 120.

In one or more embodiments, method 2300 is repeated on the second face 103 of the substrate 101, as seen in FIGS. 24C and 24D. The adhesive 116 is deposited on the second face 103, the second lens 120 is placed over the adhesive 116, and the adhesive 116 is activated such that the second lens 120 is coupled to the substrate 101.

Benefits of the present disclosure include strong adherence for waveguide devices, robustness of adhesion joints, reduction and/or distribution of stresses along waveguide devices (such as stresses in relation to adhesion joints), withstanding of thermal cycles (e.g., during operations of waveguide devices), maintaining material properties and processes, and impact resistance (such as if a waveguide device is dropped).

It is contemplated that one or more aspects disclosed herein may be combined. As an example, one or more aspects, features, components, operations and/or properties of the device 100, the adhesive 116, the lens 112, the second lens 120, the adhesive 416, the adhesive 516, the tapered section(s) 601, 602, the adhesive 616, the one or more recesses 801, the one or more recesses 901, the one or more recesses 1203, the tapered section 1405, the tapered section 1505, the openings 1701, the openings 1901, the pattern 2000, the pattern 2100, the pattern 2200, the method 2300, the adhesive 2546, and/or the method 2500 may be combined. Moreover, it is contemplated that one or more aspects disclosed herein may include some or all of the aforementioned benefits.

While the foregoing is directed to embodiments of the present disclosure, other and further embodiments of the disclosure may be devised without departing from the basic scope thereof, and the scope thereof is determined by the claims that follow.

What is claimed is:

1. A device, comprising:
a substrate having a first face, a second face, and an outer edge, wherein the first face of the substrate includes a waveguide, wherein the waveguide includes an input coupling grating, a pupil expansion grating, and an output coupling grating; and
a lens coupled to the substrate using an adhesive, the waveguide disposed radially inwardly of the adhesive, and the device having an edge offset between an outer edge of the lens and the outer edge of the substrate.

2. The device of claim 1, wherein an outer face of the lens comprises a coating formed on an inner section of the outer face, an outer section of the outer face is uncoated, and the adhesive is adhered to at least part of the outer section that is uncoated.

3. The device of claim 1, wherein the outer edge of the substrate extends radially outwardly past an outer edge of the lens, the adhesive extends radially outwardly of the outer edge of the lens, and the adhesive comprises a tapered outer face having a taper that is curved or linear.

4. The device of claim 1, wherein an outer edge of the lens extends radially outwardly past the outer edge of the substrate, and at least part of the adhesive is disposed radially outwardly of the outer edge of the substrate.

5. The device of claim 1, wherein an outer face of the lens comprises a tapered section extending to an outer edge of the lens, the tapered section is curved or linear, and the adhesive extends to bond to the tapered section.

6. The device of claim 1, wherein an outer face of the lens comprises one or more recesses, and the adhesive at least partially fills the respective one or more recesses.

7. The device of claim 1, wherein the lens comprises a plurality of openings formed in the outer edge of the lens, and the plurality of openings are azimuthally spaced from each other.

8. The device of claim 1, wherein the adhesive is formed to define a plurality of adhesive gaps that are azimuthally spaced from each other.

9. The device of claim 1, further comprising a plurality of structural adherents extending between the substrate and the lens, wherein sets of the plurality of structural adherents are azimuthally spaced from each other.

10. A device, comprising:
a substrate having a first face, a second face, and an outer edge, wherein the first face of the substrate includes a waveguide; and
a lens coupled to the substrate using an adhesive, wherein an outer face of the lens comprises a tapered section extending to an outer edge of the lens.

11. The device of claim 10, wherein the outer edge of the substrate extends radially outwardly past an outer edge of the lens, and the adhesive extends radially outwardly of the outer edge of the lens.

12. The device of claim 10, wherein the adhesive comprises a tapered outer face having a taper that is curved or linear.

13. The device of claim 10, wherein an outer edge of the lens extends radially outwardly past the outer edge of the substrate, and at least part of the adhesive is disposed radially outwardly of the outer edge of the substrate.

14. The device of claim 10, further comprising a gap between the substrate and the lens, wherein the waveguide is disposed in the gap.

15. A device, comprising:
a substrate having a first face, a second face, and an outer edge, wherein the first face of the substrate includes a waveguide; and
a lens coupled to the substrate using an adhesive, the lens comprising a first outer face adhered to the adhesive, a second outer face on an opposite side of the lens, and one or more recesses formed in the second outer face.

16. The device of claim 15, wherein at least one of the one or more recesses extends to an outer edge of the lens.

17. The device of claim 16, wherein the at least one of the one or more recesses defines a tapered section of the second outer face.

18. The device of claim 15, wherein the one or more recesses are disposed radially inwardly of an outer edge of the lens 19. The device of claim 15, further comprising a plurality of structural adherents extending between the substrate and the lens, wherein the plurality of structural adherents are azimuthally spaced from each other.

20. The device of claim 15, wherein the adhesive comprises a tapered outer face having a taper that is curved or linear.
